(19) United States
(12) Patent Application Publication
(10) Pub. No.: US 2019/0120307 A1
(43) Pub. Date: Apr. 25, 2019

(54) FLEXIBLE MOUNTING OF FRICTION LINING ELEMENTS IN BRAKE LININGS

(71) Applicant: Federal-Mogul Bremsbelag GmbH, Glinde (DE)

(72) Inventors: Mark Schlauss, Hamburg (DE); Matthias Niessner, Ismaning (DE)

(73) Assignee: Federal-Mogul Bremsbelag GmbH, Glinde (DE)

(21) Appl. No.: 15/579,679

(22) PCT Filed: Jun. 2, 2016
(86) PCT No.: PCT/EP2016/062499

§ 371 Date: Nov. 21, 2018

(30) Foreign Application Priority Data
Jun. 9, 2015 (DE) 10 2015 109 034.1

(51) Int. Cl. F16D 65/097; F16D 69/04

(52) U.S. Cl. CPC F16D 65/0975; F16D 2069/0433; F16D 69/0408

(57) ABSTRACT

To provide a brake lining for a disc brake of a vehicle, in which at least one friction lining element is arranged movably relative to the backing plate and to this end the at least one friction lining element is arranged on the backing plate by means of a spring system, with a particularly favourable force-deflection behaviour, a high degree of damping and a stable thermal behaviour, it is proposed for the spring system to have a plurality of spring elements or to consist of a plurality of spring elements.

### TECHNICAL FIELD

The invention relates to a brake lining, in particular for a disc brake of a vehicle, having a backing plate and at least one friction lining element movably arranged on the backing plate. The friction lining element is arranged on the backing plate in such a manner that, when the brake is operated, a first side face of the friction lining element can be pressed against a brake disc of the disc brake or is pressed against the brake disc. For the flexible mounting of the friction lining element, a spring system is arranged between the backing plate and the friction lining element.

Brake linings for disc brakes of vehicles usually have a backing plate, for example consisting of steel, and a friction lining arranged on the backing plate. The friction lining can be, for example, pressed thereto or connected to the backing plate in another way. The connection between the backing plate and the friction lining must withstand the forces occurring when the brake is operated, in particular the transverse forces and the forces occurring as a result of vibration stresses.

The friction material for brake linings for rail vehicles, in particular high-speed trains, is often produced from sintered material. The temperatures of the friction pairing between the brake lining and the brake disc in highly loaded brakes of this type often reach more than 600 degrees Celsius, which makes the use of conventional rubber-based brake linings difficult to impossible. To achieve uniform temperature distribution on the brake disc, the brake linings are often built up out of a plurality of friction lining elements, which are arranged individually or in groups and some of which are mounted flexibly on the backing plate of the brake lining.

### PRIOR ART

More modern sintered brake linings for rail vehicles are characterised by a multi-part structure. It is known to connect individual friction elements rigidly to the backing plate, for example, by riveting. The rigidly fastened friction elements cannot follow bumps in the brake disc and cannot compensate for different coefficients of thermal expansion. This results in high stresses in the brake disc as a result of a non-uniform temperature distribution on the brake disc and in possible overheating of individual friction elements.

These effects have been reduced by mounting friction lining elements on the backing plate in a resilient or flexible manner. For example, WO 2012/089968 A1 proposes a thin intermediate layer between the backing plate and the friction element to provide a resilient mounting.

EP 1 506 352 B1 describes a brake lining for a disc brake of a vehicle, in which friction lining elements are fastened to the backing plate by means of a loading spring and elastic elements between the friction lining elements and the backing plate.

Presentation of the Invention: Object, Solution, Advantages

The object of the present invention is to propose a brake lining for a disc brake of a vehicle, having a backing plate and a friction lining element movably arranged on the backing plate by means of a spring system, with which particularly a favourable force-deflection behaviour, a high degree of damping and stable thermal behaviour is achieved. The spring system should be capable of transmitting the transverse forces occurring during braking and as a result of shocks (for example friction forces and shock forces) from the friction lining element to the backing plate without placing further fastening elements under particular stress. It should be possible to mount the friction lining elements and the spring system on the backing plate as simply as possible without much effort.

According to the invention, a brake lining for a disc brake of a vehicle is proposed, the brake lining having a backing plate and at least one friction lining element, which is arranged on the backing plate in such a manner that, when the brake is operated, a first side face of the friction lining element can be pressed against a brake disc. Furthermore, the at least one friction lining element is arranged movably relative to the backing plate, a spring system being arranged between the backing plate and the friction lining element for this purpose. According to the invention, the spring system has a plurality of spring elements or consists of a plurality of spring elements. This means that the spring system has or consists of at least two, preferably between two and 20, spring elements.

The brake lining preferably contains sintered material. The brake lining is also preferably intended for highly loaded brakes in rail vehicles. The friction lining element can have different forms or geometries. Preferably, several friction lining elements are connected movably to the backing plate.

The at least one friction lining element has two opposing, substantially parallel side faces. The first side face faces the brake disc. The second side face of the friction lining element faces the backing plate. The friction lining element has a friction lining element support and a friction material arranged thereon. The second side face facing the backing plate is formed by the friction lining element support.

A movable arrangement of the friction lining element on the backing plate means that the friction lining element is arranged movably relative to the backing plate. The friction lining element is movable perpendicularly or in the axial direction to the backing plate. The friction lining element can also be arranged on the backing plate in such a manner that the friction lining element can be pivoted about an axis substantially parallel to the backing plate.

The spring system between the backing plate and the friction lining element is used to produce the flexible or movable connection or mounting of the friction lining element on the backing plate. When the friction lining element is mounted, the spring system is loaded or pre-loaded (pre-loading range). When a brake is operating (working range), a substantially axial pressing force acts on the friction lining element and thus on the spring system. In the process, the spring system or the plurality of spring elements of the spring system is compressed so that the friction lining element moves towards the backing plate.

The fact that the spring system has a plurality of spring element or consists of a plurality of spring elements means that a spring system can be provided which has a different spring behaviour in the pre-loading range than in the working range (when the brake is operated). Therefore, a spring system can be provided for the at least one friction lining element with which only a low pre-loading force is necessary for a relatively long pre-loading deflection. Furthermore, a large final spring force with a short spring deflection and a high degree of damping and high thermal stability can also be achieved. The elastic elements or spring elements used in the prior art for the flexible or movable arrangement of friction lining elements on a backing plate usually have a linear or slightly degressive spring behaviour.

With the brake lining according to the invention, with which the spring system in particular has a plurality of spring elements or consists of a plurality of spring elements, a particularly favourable force-deflection behaviour is achieved. It is characterised by a relatively low pre-loading force with a long pre-loading deflection and a large final force with a short working deflection. The spring system of the brake lining according to the invention thus has a progressive spring behaviour, in contrast to the arrangements known from the prior art. Low pre-loading ensures that the spring system can deform even under small jaw forces. Large pre-loading forces, however, allow a system to act rigidly under small jaw forces, which is associated with negative consequences for temperature distribution on the backing plate and the progression of friction coefficients. In contrast, small pre-loading forces cause less stress in the fastening means with which the friction lining element is connected to the backing plate. A long pre-loading deflection is associated with a relatively shallow force-deflection curve and promotes the compensation of setting phenomena in the spring system or an unfavourable tolerance stackup of the fastening means with a shortened pre-loading deflection. Both effects result in low pre-loading losses. In contrast, if a spring with a sharply increasing curve in the pre-loading range is used, setting of the spring and/or a short pre-loading deflection can rapidly lead to a loose connection and rattling.

Furthermore, a loading spring on the rear of the backing plate is no longer necessary with the brake lining according to the invention.

A large spring force in the end position means that the spring system can still deform and does not behave rigidly under large jaw forces. A solid position can thus be avoided. A short working deflection to the end position is advantageous for complying with installation space requirements on the basis of standardised brake lining thicknesses.

The fact that the spring system has or consists of several spring elements means that an additional damping system or additional damping element are not needed to damp or suppress noise. A high degree of intrinsic mechanical damping is already achieved owing to the plurality of spring elements.

Furthermore, a stable thermal behaviour is achieved with the brake lining according to the invention. Elastic deformability can be maintained in the event of thermal overloading. The temperature resistance and the ability to tolerate overloading are improved by the multi-layered structure of the spring system and by the plurality of spring elements in the spring system. Preferably, the individual spring elements of the spring system do not rest against each other over their full area. Gaps remaining between individual spring elements or between regions of individual spring elements act as obstacles to thermal conduction and result in low temperatures in the spring layers remote from the friction lining elements.

Preferably, the at least one friction lining element is connected to the backing plate by means of a fastening means, the spring elements of the spring system being arranged around the fastening means, at least in some regions. The fastening means is used for fastening or connecting the at least one friction lining element to the backing plate. The fastening means can also be designed to produce pre-loading of the spring system. When the at least one friction lining element is connected to the backing plate by means of the fastening element, the friction lining element is pressed against the spring system or against individual spring elements of the spring system so that pre-loading of the spring system is achieved.

Furthermore, the individual spring elements of the spring system are preferably substantially planar. For example, the individual spring elements of the spring system can be disc-shaped or bowl-shaped. The planar spring elements can then be curved, bent or contoured.

Preferably, the individual spring elements of the spring system are arranged in a parallel stack relative to each other. This means that the spring elements of the spring system are arranged relative to each other such that they act as a parallel stack, at least in the working range.

So that a spring system with progressive spring behaviour can be provided, it is advantageously provided for the individual spring elements of the spring system to have different stiffnesses. Particularly preferably, the individual spring elements of the spring system consist of the same materials.

Advantageously, the different stiffnesses of the spring elements of the spring system are achieved by different thicknesses of the individual spring elements and/or different spring heights or spring deflections of the individual spring elements. For example, a spring system could consist of several planar spring elements arranged one above the other, the individual spring elements having different thicknesses and/or different spring heights or spring deflections. This produces a spring system with a multi-flexible spring curve. During mounting of the friction lining elements and pre-loading of the spring system, the spring element with a shallower spring curve is loaded first. A small pre-loading force can be combined with a relatively long pre-loading deflection thereby. During operation, that is, in the working range, the other spring elements then act in addition to the spring element with the shallower spring curve. The spring curve is then steeper in some sections in the working range than in the pre-loading range. A large final force can thus be achieved after a relatively small deflection. The individual spring elements are then stacked parallel as soon as they come into planar contact with each other.

Advantageously, the individual spring elements of the spring system are in the form of Belleville washers. To produce a parallel stack of the individual spring elements in the form of Belleville washers, they are arranged substantially one above the other and facing in the same direction. Belleville washers are usually closed around the circumference and have an inner diameter and an outer diameter. The spring elements which are preferably in the form of Belleville washers have an inclination angle of between 4 and 15 degrees, particularly preferably between 6 degrees and 12 degrees, and very particularly preferably between 6 degrees and 10 degrees, from the inner circumference to the outer circumference. For example, an inclination angle of 8 degrees could be provided.

Furthermore, all or else only individual spring elements of the spring system can have cut-outs along their inner and/or outer circumference. The provision of cut-outs in the spring elements means that spring elements having different stiffnesses can be provided. The cut-outs can have any suitable width. For example, the cut-outs can be in the form of slots or wider cut-outs. A tab is formed between each pair of cut-outs by the two cut-outs. Preferably, several cut-outs are provided uniformly distributed around the circumference of the spring elements. During mounting and pre-loading, the tabs, formed by the cut-outs, of the spring elements are substantially bent first. Depending on the width and depth of the individual cut-outs, a relatively shallow spring curve can be achieved initially in the pre-loading range. The pre-loading force thus remains small. With increasing deformation, further regions of the spring elements are effective, as a result of which the spring behaviour in the working range changes. In particular, a relatively stiff spring behaviour can be achieved in the working range of the spring system, in comparison with the pre-loading range.

Furthermore, the spring system preferably has at least one wound or layered wave spring with several turns. In this case, each turn forms a spring element of the spring system. A wave spring below means a substantially wound spring consisting of flat, corrugated wire. The wave spring can have homogeneous and uniform turns or turns with different wave heights. For example, a wave spring can be provided which has two or more regions with different wave heights or turn heights. In the pre-loading range of the wave spring, the region with the greater wave height or turn height is then substantially effective. Since only a few layers are preferably provided for this purpose, the stiffness in the pre-loading range is relatively low. As soon as all the layers in the wave spring lie on each other, the stiffness of the wave spring increases. All the turns and spring elements are then deformed in the working range.

Furthermore, the spring system can preferably have several wave springs which are arranged one inside the other. A first wave spring can thus be arranged around a second wave spring. More than two wave springs can also be arranged one inside the other or one around the other. In this case, the outer diameter of the second wave spring, which is arranged inside the first wave spring, can be smaller or equal to the outer diameter of the first wave spring, which is arranged around the second wave spring. The wave springs can have different stiffnesses.

The spring system preferably has one or more wave washers. A wave washer is a wave spring in which the individual turns are in the form of Belleville washers. A wave washer therefore combines the washer shape of a Belleville washer with the waves of a wave spring. The sheet thickness is preferably between 0.4 mm and 1 cm, particularly preferably between 0.5 mm and 0.8 mm, for example 0.7 mm. Each turn or winding in turn forms an individual spring element. Preferably, each turn or winding has several waves, for example between 3 and 8, particularly preferably between 4 and 6. The inclination angle of the individual spring elements or turns is preferably between 4 degrees and 12 degrees, particularly preferably between 6 degrees and 10 degrees, for example 8 degrees.

The spring system is preferably arranged between the backing plate and the friction lining element in such a manner that a first edge of the spring elements bears against a first bearing face formed by a first flange or a raised portion. The first flange or the raised portion protrudes from a second side face, that is, the side face of the friction lining element which faces the backing plate. The first edge of a spring element is preferably formed by the inner circumference of the respective spring element. A second edge of a spring element is preferably formed by the outer circumference of the respective spring element. The first flange is preferably arranged around a fastening means or a bore through the friction lining element. When an axial compressive force is exerted on the friction lining element, the spring elements of the spring system press against the first flange or the raised portion on the friction lining element. The first flange or the raised portion is designed and arranged on the friction lining element in such a manner that a first bearing face is formed, which is aligned or arranged substantially perpendicular to the underside, that is, the second side face of the friction lining element. The first flange or the raised portion can be formed integrally with the friction lining element support of the friction lining element.

Furthermore, the backing plate preferably has a depression and/or a second flange protruding from the backing plate. The spring system is preferably arranged between the backing plate and the friction lining element in such a manner that the second edge of the individual spring elements bears against a second bearing face. The second bearing face is formed by a lip running around the depression and/or by the second flange. The depression and/or the second flange are arranged in the region of the first side face of the backing plate. The depression and/or the second flange are thus arranged on the side face of the backing plate facing the friction lining element. The depression is thus used to receive and guide the spring system or the spring elements of the spring system. For this purpose, the depression can correspond substantially to the dimensions of the outer diameter of the individual spring elements. The depression can alternatively be larger and act to receive several spring systems, which are associated with different friction lining elements. Friction lining elements which are arranged displaceably to each other can be provided thereby.

When an axial compressive force is exerted on the friction lining element, the spring elements thus press not only against a bearing face (first bearing face) on the friction lining element but also against a bearing face (second bearing face) on the backing plate. The depression or the lip running around the depression or the second flange on the backing plate is designed or arranged in such a manner that the second bearing face is oriented substantially perpendicular to the first side face of the backing plate. Particularly preferably, the spring system is guided in a recess or depression in the backing plate on the outside. In the inner diameter, the spring system is supported on the friction lining element by a flange, for example a cylindrical step, on the friction lining element. The play between the recess or depression and the spring elements and the play between the spring elements and the first flange on the friction lining element is selected to be such that increased friction occurs at the contact points when the spring elements are deformed. This increases the overall damping of the multi-layered spring system. The structural design allows the spring system to transmit the transverse forces occurring during braking and as a result of shocks (for example, friction forces and shock forces) from the friction lining element to the backing plate.

The spring elements also preferably have, at least in some regions, a coating containing a friction-increasing material to increase the friction at contact faces between the spring elements and the backing plate and/or the friction lining element. The coating can also be provided around the full circumference and completely around the spring elements. Preferably, the contact faces on the backing plate and/or friction lining elements can also be coated. The coating can be in the form of a particulate casing. For example, reinforcing particles of silicon carbide (SiC particles) can be provided for this purpose. This further increases the damping of the multi-layered structure of the spring system.

The fastening means for fastening the friction lining element to the backing plate can be, for example, in the form of a screw connection or plug-in connection. To this end, the friction lining element is preferably connected by means of a screw connection or plug-in connection having a socket arranged in a bore through the backing plate. In contrast to the fastening means for fastening friction lining elements to a backing plate known from the prior art, the preferably provided fastening means, for example a screw or bolt, is not screwed directly into a bore through the backing plate but with a socket arranged in this bore through the backing plate. The fact that a socket is provided in the bore through the backing plate to receive the fastening means, for example the screw or a bolt rather than, for instance, a screw being screwed directly into the bore through the backing plate without a socket, means that the transverse force is transmitted away via the friction lining element to the socket when the brake is operated. The stress on the backing plate in this region is thus reduced. This is also achieved when the fastening means is fastened by means of an elastic closure means for securing the axial position of the fastening means inside the bore. In both cases, the quality and service life of the brake lining can be increased. Furthermore, the friction lining element is guided in the perpendicular direction or axial direction by a fastening of this type. These fastenings also allow simple mounting. The fastening means can preferably be in the form of a screw or bolt. The friction lining element is then connected to the socket arranged in the bore through the backing plate by means of a screw connection. To this end, the screw has an outer thread and the socket has an inner thread, at least in some regions. If a bolt is used, a fixing element (for example a snap ring) engages in circumferential grooves in the bolt and the socket, for example, and prevents axial shifting of the bolt in the socket.

In principle, the friction lining element can have any form or geometry. The basic shape of the friction lining element is preferably substantially round, oval, triangular, square, rectangular or trapezoidal. This means that only the basic shape is formed in this way. For example, the corners can be rounded without the basic shape being changed. It is thus provided for example for the friction lining element to have a substantially triangular or trapezoidal basic shape with rounded corners.

Several friction lining elements can be arranged on the backing plate. For the arrangement of the preferably provided further friction lining elements on the backing plate, the same inventive and preferred features are provided as for the arrangement of the at least one friction lining element. Particularly preferably, more than three, very particularly preferably, more than four friction lining elements are arranged on the backing plate. If several friction lining elements are arranged on the backing plate, the friction lining elements are also referred to as friction lining segments. The brake lining thus preferably has a segmented friction lining, the individual segments being formed by the friction lining elements.

According to the invention, a spring system with several spring elements is also provided for arrangement between a backing plate and a friction lining segment of a brake lining. The spring system has at least one wound or layered wave spring, each turn of the wave spring forming a spring element of the spring system. The individual turns of the wave spring are formed like Belleville washers. Therefore, a spring system having one or more wave washers is also provided according to the invention.

According to the invention, a disc brake for a vehicle, in particular a rail vehicle, is also provided, the disc brake having a brake lining according to one of claims 1 to 19.

### BRIEF DESCRIPTION OF THE DRAWINGS

In the figures:

FIG. 1: schematically shows a perspective view of a brake lining,

FIG. 2: schematically shows a sectional diagram through a region of a brake lining,

FIGS. 3a and b: schematically show a spring system with the individual spring elements in the form of Belleville washers,

FIG. 4: schematically shows a spring system with the individual spring elements in the form of Belleville washers with cut-outs,

FIGS. 5a and b: schematically show a spring system with the individual spring elements in the form of wave washers,

FIGS. 6a and b: schematically show a spring system formed by a wave spring,

FIG. 7: schematically shows a spring system with an anti-rotation means, and

FIG. 8: schematically shows a diagram with curves for different profiles of the force-deflection spring curve.

### PREFERRED EMBODIMENTS OF THE INVENTION

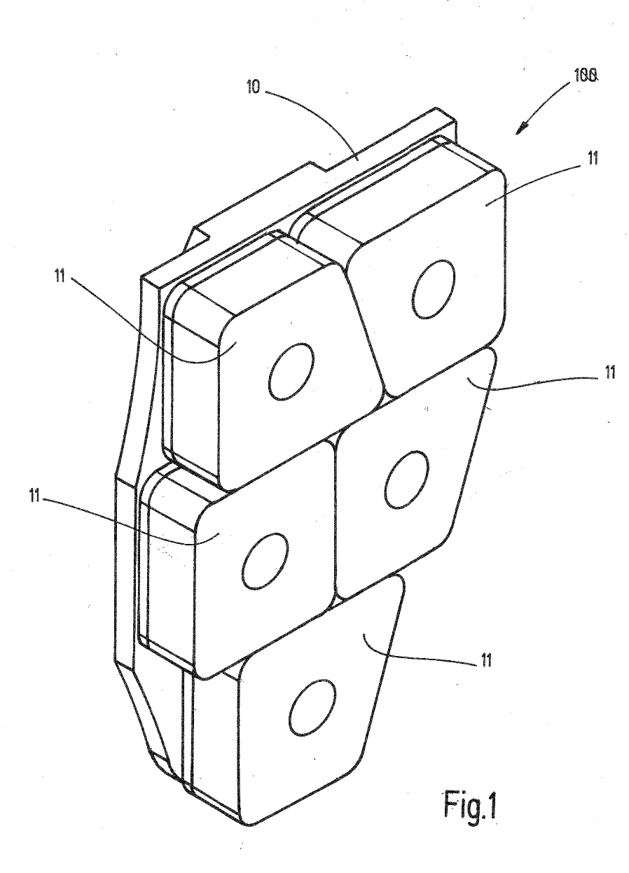

FIG. 1 shows a perspective view of a brake lining 100. Individual friction lining elements 11 are movably arranged on the backing plate 10 of the brake lining 100. To this end, the individual friction lining elements 11 are mounted on the backing plate 10 by means of a spring system 14 (not shown in FIG. 1).

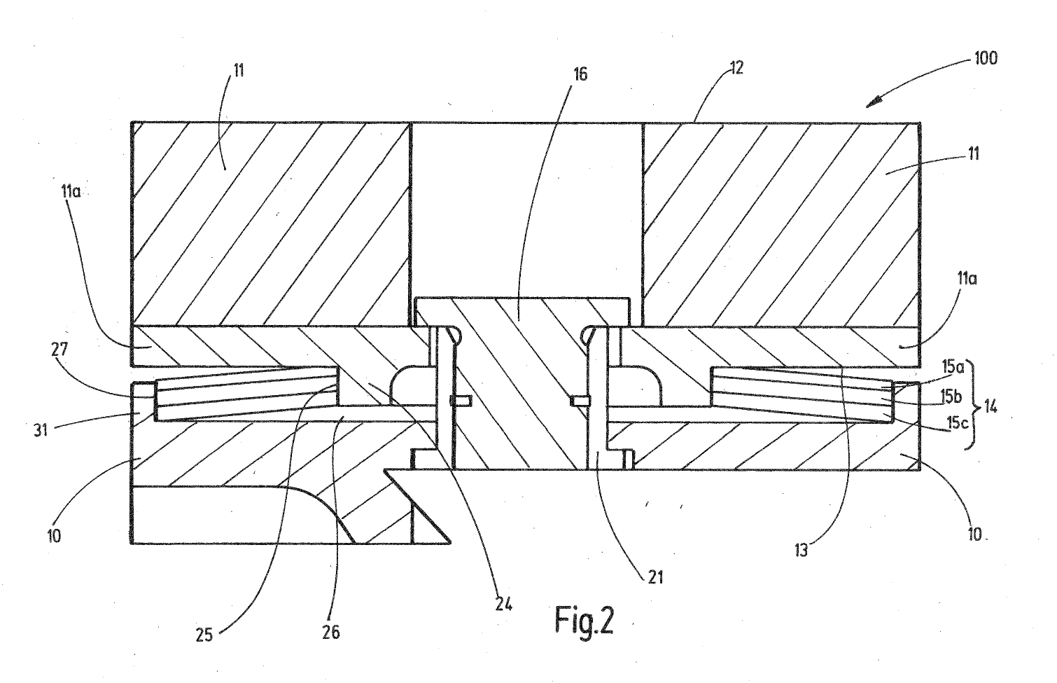

FIG. 2 shows a sectional diagram through a region of the brake lining 100 of FIG. 1. The region in which a friction lining element 11 is fastened to the backing plate 10 by means of a fastening means 16 is shown here. The fastening means 16 is in the form of a bolt. A socket 21 is arranged in a bore through the backing plate 10. The fastening means 16 in the form of a bolt is inserted into the socket 21 and is held by a fixing means.

A spring system 14 is arranged around the fastening means 16 between the backing plate 10 and the friction lining element 11. The spring system 14 has three planar spring elements 15a, 15b, 15c arranged one above the other. In the position shown in FIG. 2, the spring system 14 is shown in the pre-loaded state. The spring system 14 is pre-loaded when the fastening means 16 is introduced into the socket 21.

The individual spring elements 15a, 15b, 15c of the spring system 14 are stacked parallel to each other. A depression 26 is arranged in the backing plate 10 to receive the spring system 14. A first flange 24 is arranged around the fastening means 16 on the underside, that is, on the second side face 13, of the friction lining element 11. This first flange 24 forms a first bearing face 25 for supporting a first edge 22 of the spring elements 15a, 15b, 15c. A second bearing face 27 for supporting a second edge 23 of the spring elements 15a, 15b, 15c is formed by the lip 31 running around the depression 26 in the backing plate 10. The spring system 14 is thus guided in the depression 26 in the backing plate 10 on the outside. In the inner diameter of the spring system 14, it is supported against a substantially cylindrical step or on the first flange 24 on the friction lining element 11.

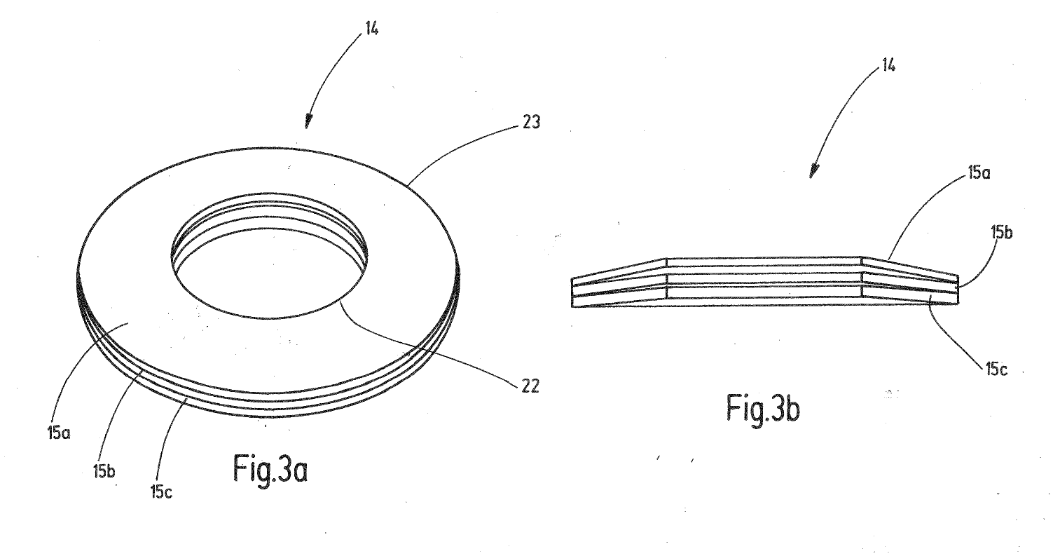

The desired particularly favourable force-deflection behaviour of the spring system 14 is characterised by a relatively small pre-loading force with a long pre-loading deflection and a large final force with a short working deflection. This is achieved by a progressive spring behaviour of the spring system 14. To this end, the spring system 14 has several spring elements 15a, 15b, 15c, which are substantially planar and are stacked parallel to each other. Furthermore, a progressive spring behaviour is achieved in that the individual spring elements 15a, 15b, 15c have different stiffnesses. FIGS. 3 to 6 show, by way of example, arrangements of spring systems 14 having several planar spring elements 15a, 15b, 15c, the spring systems 14 being designed such that they have a progressive spring behaviour.

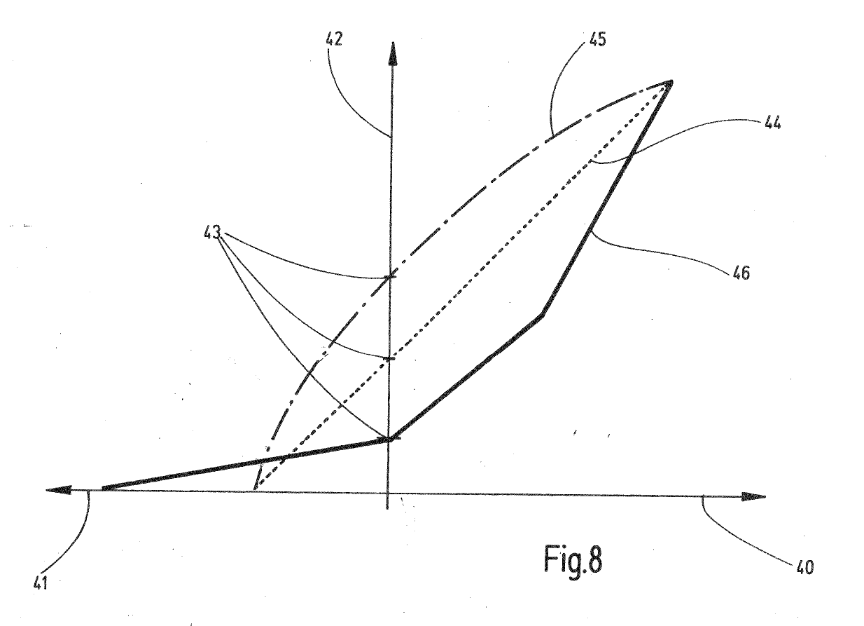

FIGS. 3a and 3b show a spring system 14 in which the spring elements 15a, 15b, 15c are in the form of Belleville washers. Here, the top Belleville washer has a smaller thickness than the other two Belleville washers and a different spring height or a different spring deflection. This produces a multi-flexible spring curve (cf. FIG. 8). During mounting and during pre-loading, the top Belleville washer acts with a shallow spring curve in the pre-loading range. A small pre-loading force can be combined with a relatively long pre-loading deflection thereby. During operation, the middle Belleville washer is effective in addition to the top Belleville washer in the working range, and the bottom Belleville spring is also effective on further deformation. The spring curve is thereby steeper in some sections; a large final force can thus be achieved after a relatively small deflection. The spring elements 15a, 15b, 15c in the form of Belleville washers act as a parallel stack as soon as they come into planar contact.

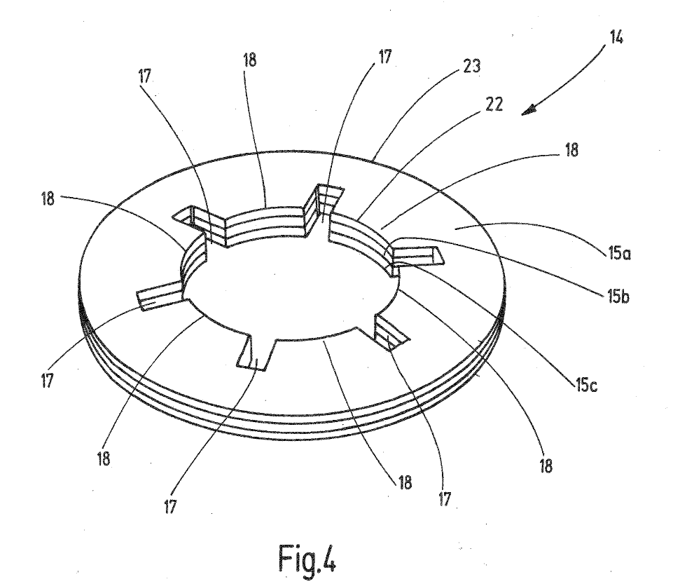

FIG. 4 likewise shows a spring system 14 in which the individual spring elements 15a, 15b, 15c are in the form of Belleville washers. The different stiffnesses are in this case achieved by cut-outs 17 in the inner circumference or along the first edge 22 of the spring elements 15a, 15b, 15c. During mounting and pre-loading of the spring system, the inner tabs 18 of the Belleville washers substantially bend. This region can be relatively flexible depending on the width and depth of the cut-outs 17, which makes the spring curve initially relatively shallow. The pre-loading force thus remains small. With increasing deformation, the outer region of the spring system 14 in the form of a Belleville washer stack acts like a conventional Belleville washer stack with a large inner diameter to outer diameter ratio and thus relatively stiffly. This region is the working range of the spring system 14. In principle, the cut-outs 17 can be arranged along the first edge 22 (along the inner circumference) and/or along the second edge 23 (along the outer circumference) of the spring elements 15a, 15b, 15c.

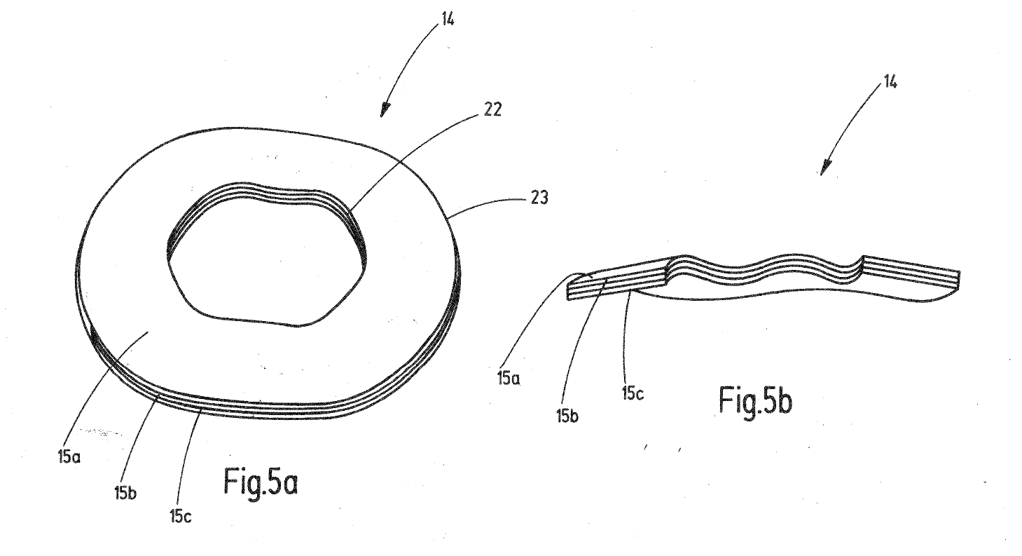

FIG. 5 shows a spring system 14 in which the individual spring elements 15a, 15b, 15c are in the form of wave washers. What are known as wave washers combine the washer shape of a Belleville washer with the waves of a wave spring. At the start of deformation, that is, in the pre-loading range, the spring system 14 acts like a Belleville washer stack. The spring force is small owing to a relatively small sheet thickness, for example within the range between 0.5 mm and 0.8 mm. As soon as the individual spring elements 15a, 15b, 15c of the spring system 14 in the form of a wave washer are pressed into a flat state, the spring system 14 acts like a wave spring with a linearly rising curve. A small sheet thickness is advantageous for reducing the bending stress which can rapidly reach impermissibly high values in the case of thick sheets.

The spring system 14 shown in FIG. 5 has spring elements 15a, 15b, 15c with the same wave heights at the inner and outer diameters. To adjust the stiffness of the waves, the wave height can also be different on the inside and outside. The wave height of the spring elements 15a, 15b, 15c is preferably smaller at the inner diameter than in the region of the outer diameter, since the stresses in the spring system can also be reduced thereby.

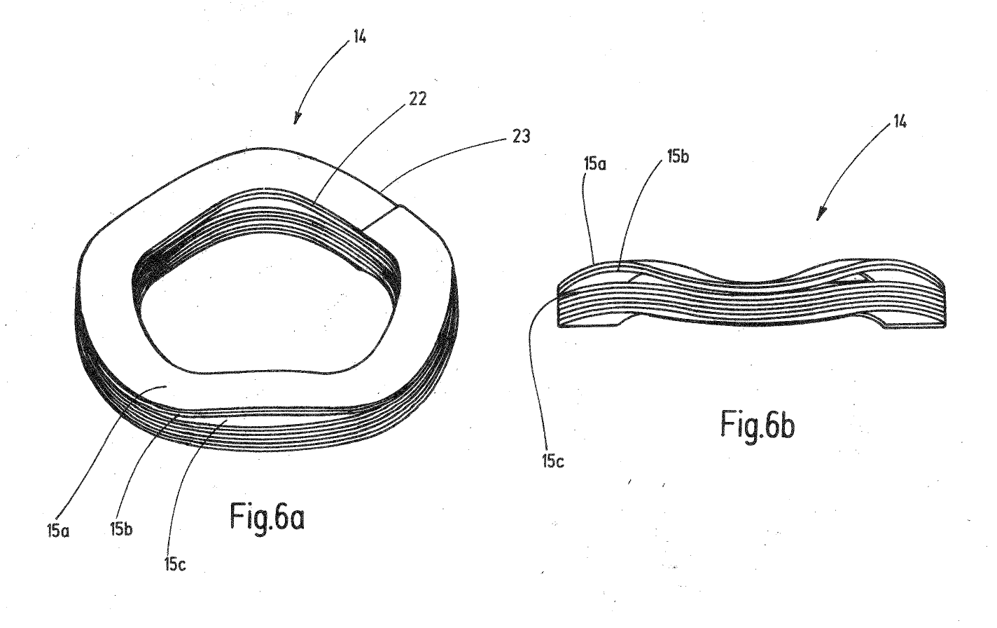

FIG. 6 shows a spring system 14 in the form of a wave spring. Each turn of the spring system 14 in the form of a wave spring forms a spring element 15a, 15b, 15c. The spring system 14 shown in FIG. 6 consists, by way of example, of two regions of different turn heights. In the pre-loading range of the spring system, the region of greater wave height is substantially effective, in this example the top two turns (corresponds to the spring elements 15a and 15b). Since only a few layers are deformed, the stiffness and thus the pre-loading force are relatively small. As soon as all the layers lie on each other, the stiffness of the spring system 14 increases. All the turns or all the spring elements 15a, 15b, 15c are then deformed in the working range.

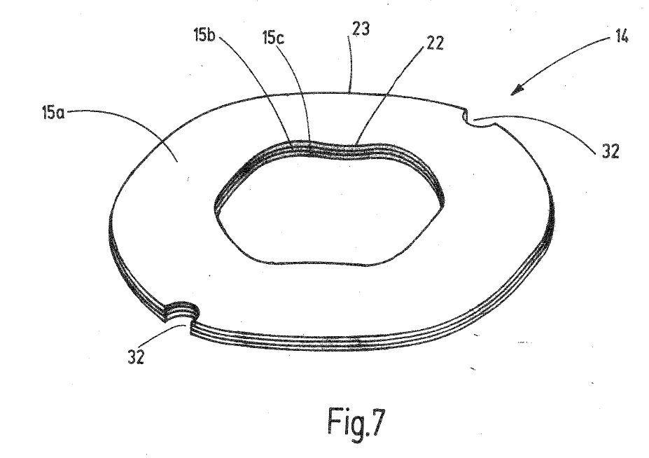

FIG. 7 shows a spring system 14 with an anti-rotation means. To this end, the individual spring elements 15a, 15b, 15c have grooves 32 on the second edge 23 thereof or along the outer circumference. Alternatively to the grooves, protruding tabs could also be provided. The grooves 32 are arranged such that they engage in corresponding mating pieces on the friction lining element 11 or on the backing plate 10. The anti-rotation means thus ensures that individual spring elements 15a, 15b, 15c do not rotate relative to each other and thus a parallel stack of the individual spring elements 15a, 15b, 15c is maintained. For example, pin-like raised portions on the backing plate 10 could engage in the grooves 32 arranged on the outer circumference of the spring elements 15a, 15b, 15c and thus prevent rotation.

FIG. 8 shows different profiles of a force-deflection spring curve of different spring systems. On the x axis, the pre-loading deflection 41 is shown in the left-hand half and the working deflection 40 is shown in the right-hand half. The spring force 42 is shown on the y axis. FIG. 8 shows three different spring curves 44, 45, 46. A linear spring curve 44 is shown using a dotted line. A degressive spring curve 45 is shown using a dash-dotted line. The solid curve shows the profile of the spring system 46 according to the invention; the number of regions of different gradient depends on the design of the spring system. The intersections of the curves with the y axis show the necessary pre-loading force 42 for the respective spring system.

A small pre-loading force 43 ensures that the spring system 14 can deform even under small jaw forces. Large pre-loading forces 43, however, allow a spring system to act rigidly under small jaw forces, which is associated with negative consequences for temperature distribution on the backing plate and the progression of friction coefficients. In addition, the small pre-loading forces 43 place less stress on fastening means 16. A long pre-loading deflection 41 is associated with a relatively shallow force-deflection curve, which helps to compensate setting phenomena in the spring system 14 or an unfavourable tolerance stackup of the fastening means 16 with a shortened pre-loading deflection 41. Both effects result in only low pre-loading losses in this case. If a spring system with a sharply increasing curve in the pre-loading range is used, setting of the spring system and/or a short pre-loading deflection 41 can rapidly lead to a loose connection and rattling.

A large spring force in the end position means that the spring system 14 can still deform and does not behave rigidly under large jaw forces. A short working deflection to the end position is applied to comply with installation space requirements, for example for standardised brake lining thicknesses.

A high degree of damping, that is, a pronounced hysteresis, helps to suppress noise in addition to a possible non-degressive curve. Therefore, no additional damping elements are necessary for a high degree of damping. The multi-layered spring system 14 has a high degree of intrinsic mechanical damping.

A stable thermal behaviour means that elastic deformability is maintained in the event of thermal overloading. The temperature resistance and the ability to tolerate overloading are improved by the multi-layered structure of the spring system 14. The multi-layered spring system or the spring elements 15a, 15b, 15c of the spring system 14 do not generally lie fully on each other. Remaining gaps act as obstacles to thermal conduction and result in lower temperatures in the spring layers remote from the friction lining elements 11.

### REFERENCE SYMBOLS

100 Brake lining
200 Disc brake
10 Backing plate
11 Friction lining element
11a Friction lining element support
12 First side face of friction lining element
13 Second side face of friction lining element
14 Spring system
15, 15a, 15b, 15c Spring elements
16 Fastening means
17 Cut-out
18 Tab
19 Turns of a wave spring
20 Bore through backing plate
21 Socket
22 First edge of spring elements
23 Second edge of spring elements
24 First flange
25 First bearing face
26 Depression in backing plate
27 Second bearing face
28 First side face of backing plate
29 Second side face of backing plate
30 Second flange
31 Lip
32 Groove
40 Working deflection
41 Pre-loading deflection
42 Spring force
43 Pre-loading force
44 Linear spring curve
45 Degressive spring curve
46 Curve of spring system according to the invention

1-21. (canceled)

22. A brake lining for a disc brake of a vehicle, having a backing plate and at least one friction lining element, the friction lining element being arranged on the backing plate such that, when the brake is operated, a first side face of the friction lining element can be pressed against a brake disc, the friction lining element being arranged movably relative to the backing plate, a spring system being arranged between the backing plate and the friction lining element, characterised in that the spring system has or consists of a plurality of spring elements.

23. The brake lining according to claim 22, characterised in that the friction lining element is connected to the backing plate by means of a fastening means, wherein the spring elements are arranged in at least some regions around the fastening means, wherein the fastening means is designed to produce a pre-loading of the spring system.

24. The brake lining according to claim 22, characterised in that the spring elements are substantially planar.

25. The brake lining according to claim 22, characterised in that the spring elements are designed such that the spring system has a different spring behaviour in a pre-loading range than in a working range, that is, when the brake is operated.

26. The brake lining according to claim 22, characterised in that the spring elements are stacked parallel to each other.

27. The brake lining according claim 22, characterised in that the spring elements have different stiffnesses.

28. The brake lining according to claim 22, characterised in that the spring elements have different thicknesses.

29. The brake lining according to claim 22, characterised in that the spring elements have different spring heights.

30. The brake lining according claim 22, characterised in that the spring elements are in the form of Belleville washers.

31. The brake lining according to claim 22, characterised in that at least one spring element has cut-outs (17) along the inner circumference and/or outer circumference thereof.

32. The brake lining according to claim 22, characterised in that the spring system has at least one wound or layered wave spring having a plurality of turns, wherein each spring element is formed by one turn.

33. The brake lining according to claim 32, characterised in that the spring system has a plurality of wave springs, wherein a first wave spring is arranged around a second wave spring.

34. The brake lining according to one of claim 32, characterised in that the individual turns are formed like Belleville washers.

35. The brake lining according to claim 22, characterised in that the spring system is arranged between the backing plate and the friction lining element in such a manner that the spring elements bear with a first edge (22) against a first bearing face (25) formed by a first flange (24) or a raised portion, wherein the first flange (24) or the raised portion protrudes from a second side face (13) of the friction lining element, wherein the second side face (13) faces the backing plate.

36. The brake lining according to claim 22, characterised in that the backing plate has a depression and/or a second flange protruding from the backing plate, wherein the spring system is arranged between the backing plate and the friction lining element in such a manner that the spring elements bear with a second edge against a second bearing face, wherein the second bearing face is formed by a lip (31) running around the depression and/or by the second flange.

37. The brake lining according to claim 22, characterised in that the spring elements have, at least in some regions, a coating containing a friction-increasing material for increasing the friction at contact faces between the spring elements and the backing plate and/or the friction lining element.

38. The brake lining according to claim 22, characterised in that the friction lining element is connected by means of a connection having a socket arranged in a bore through the backing plate.

39. The brake lining according to claim 22, characterised in that the friction lining element has a substantially round, oval, triangular, square, rectangular or trapezoidal basic shape.

40. The brake lining according to claim 22, characterised in that several, preferably more than three, friction lining elements are arranged on the backing plate.

41. A spring system having a plurality of spring elements for arrangement between a backing plate and a friction lining element of a brake lining according to claim 22, characterised in that the spring system has at least one wound or layered wave spring having a plurality of turns, wherein each spring element is formed by one turn and the individual turns are formed like Belleville washers.

42. A disc brake for a vehicle, in particular a rail vehicle, according to claim 22 characterised in that the disc brake has a brake lining that comprises the friction lining element is connected to the backing plate by means of a fastening means, wherein the spring elements are arranged in at least some regions around the fastening means, wherein the fastening means is designed to produce a pre-loading of the spring system.
